(19) United States
(12) Patent Application Publication
(10) Pub. No.: US 2018/0219461 A1
(43) Pub. Date: Aug. 2, 2018

(54) ROBOT

(71) Applicant: Seiko Epson Corporation, Tokyo (JP)

(72) Inventors: Hidenori HAMA, Shimosuwa (JP); Seiji HAHAKURA, Azumino (JP); Yoshiteru NISHIMURA, Shiojiri (JP); Takema YAMAZAKI, Fujimi (JP)

(21) Appl. No.: 15/885,986

(22) Filed: Feb. 1, 2018

(30) Foreign Application Priority Data
Feb. 2, 2017 (JP) 2017-017892

(51) Int. Cl. H02K 11/33; H02K 29/08; H02K 11/215

(52) U.S. Cl. CPC H02K 11/33; H02K 2211/03; H02K 11/215; H02K 29/08

(57) ABSTRACT

A robot includes a motor, an amplifier that includes a drive circuit for driving the motor, and a first object that includes at least one of a brake which brakes a driving shaft of the motor, a pulley which transmits a motive power from the driving shaft of the motor, and a computing unit which performs calculation related to rotation of the motor, in which the motor is provided with the amplifier such that the amplifier is positioned at a position other than a position axially above the driving shaft.

### BACKGROUND

### 1. Technical Field

The present invention relates to a robot.

### 2. Related Art

Research and development for a motor that drives each joint of a robot are being performed.

With regard to this, an electric driving device that is provided with a motor and a control unit as a driving unit disposed on a side opposite an output shaft side of the motor has been known. In the electric driving device, a detecting target portion of a rotation angle sensor is provided on an end portion of a shaft that is on the side opposite the output shaft side of the motor and a sensor unit as a detecting unit of the rotation angle sensor is provided to be coaxially positioned with a rotation axis of the shaft. In the control unit, an inverter circuit section that is attached to a heat sink and that includes a driving element for driving the motor and a control substrate that is separated from the sensor unit and that controls output of the inverter circuit section are provided. The sensor unit and the control substrate are electrically connected to each other and the control substrate is disposed along a plane perpendicular to the rotation axis of the shaft of the motor (refer to Re-published WO 2014/054098).

However, in a case where a brake is attached to the shaft in such an electric driving device, since three elements of the sensor unit, the control unit (that is, an amplifier), and the brake are disposed to be arranged in a direction along the rotation axis of the motor, it is difficult to make the entire length of the electric driving device short in some cases.

### SUMMARY

An aspect of the invention is directed to a robot including a motor, an amplifier unit that includes a drive circuit for driving the motor, and a first object that includes at least one of a braking unit which brakes a driving shaft of the motor, a motive power transmitting unit which transmits a motive power from the driving shaft of the motor, and a computing unit which performs calculation related to rotation of the motor, in which the motor is provided with the amplifier unit such that the amplifier unit is positioned at a position other than a position axially above the driving shaft.

According to this configuration, in the robot, the motor is provided with the amplifier unit such that the amplifier unit is positioned at a position other than a position axially above the driving shaft of the motor. Therefore, according to the robot, it is possible to reduce the length of a member, which is obtained by assembling the motor and the amplifier unit, in a direction along the driving shaft of the motor.

In another aspect of the invention, the robot may be configured such that the amplifier unit includes a substrate including the drive circuit, and the motor is provided with the substrate such that the substrate becomes parallel to the driving shaft.

According to this configuration, in the robot, the amplifier unit includes the substrate including the drive circuit, and the motor is provided with the substrate such that the substrate becomes parallel to the driving shaft of the motor. Therefore, according to the robot, it is possible to reduce the length of the member, which is obtained by assembling the motor and the amplifier unit, in the direction along the driving shaft of the motor corresponding to the length of the substrate with which the motor is provided such that the amplifier substrate becomes parallel to the driving shaft of the motor.

In another aspect of the invention, the robot may be configured such that the first object and the motor are positioned axially above the driving shaft.

According to this configuration, in the robot, the first object and the motor are positioned axially above the driving shaft. Therefore, according to the robot, it is possible to reduce the length of a member, which is obtained by assembling the first object, the motor, and the amplifier unit, in the direction along the driving shaft of the motor.

In another aspect of the invention, the robot may be configured such that the computing unit includes a control substrate including a control circuit that controls the motor.

According to this configuration, in the robot, the computing unit includes the control substrate including the control circuit that controls the motor. Therefore, according to the robot, it is possible to reduce the length of a member, which is obtained by assembling the computing unit that includes the control substrate including the control circuit that controls the motor, the motor, and the amplifier unit.

In another aspect of the invention, the robot may be configured such that the control substrate is provided axially above the driving shaft.

According to this configuration, in the robot, the control substrate is provided axially above the driving shaft of the motor. Therefore, according to the robot, it is possible to reduce the length of a member, which is obtained by assembling the computing unit including the control substrate that is provided axially above the driving shaft of the motor, the motor, and the amplifier unit.

In another aspect of the invention, the robot may be configured such that the control substrate is positioned in an angle detector.

According to this configuration, in the robot, the control substrate is positioned in the angle detector. Therefore, according to the robot, it is possible to reduce the length of a member, which is obtained by assembling the computing unit that includes the control substrate positioned in the angle detector, the motor, and the amplifier unit.

In another aspect of the invention, the robot may be configured such that the first object includes the braking unit, the motive power transmitting unit, and the computing unit.

According to this configuration, in the robot, the first object includes the braking unit, the motive power transmitting unit, and the computing unit. Therefore, according to the robot, it is possible to reduce the length of a member, which is obtained by assembling the first object including the braking unit, the motive power transmitting unit, and the computing unit, the motor, and the amplifier unit.

In another aspect of the invention, the robot may be configured such that the robot further includes a base, a first arm provided on the base, and a control device that controls the first arm and at least a portion of the control device is positioned in the base.

According to this configuration, in the robot, at least a portion of the control device is positioned in the base. Therefore, according to the robot in which at least a portion of the control device is positioned in the base, it is possible to reduce the length of the member, which is obtained by assembling the motor and the amplifier unit, in the direction along the driving shaft of the motor.

In another aspect of the invention, the robot may be configured such that the first arm is provided on the base such that the first arm is rotatable around a first rotation axis, and the robot further includes a first casing that partially overlaps with the base as seen in an axial direction of the first rotation axis.

According to this configuration, in the robot, the first arm is provided on the base such that the first arm is rotatable around the first rotation axis, and the robot further includes the first casing that partially overlaps with the base as seen in an axial direction of the first rotation axis. Therefore, according to the robot including the first casing, it is possible to reduce the length of the member, which is obtained by assembling the motor and the amplifier unit, in the direction along the driving shaft of the motor.

In another aspect of the invention, the robot may be configured such that the robot is a horizontal articulated robot.

According to this configuration, the robot is the horizontal articulated robot. Therefore, according to the robot being horizontal articulated robot, it is possible to reduce the length of the member, which is obtained by assembling the motor and the amplifier unit, in the direction along the driving shaft of the motor.

According to the aspect, in the robot, the motor is provided with the amplifier unit such that the amplifier unit is positioned at a position other than a position axially above the driving shaft. Therefore, according to the robot, it is possible to reduce the length of the member, which is obtained by assembling the motor and the amplifier unit, in the direction along the driving shaft of the motor.

### BRIEF DESCRIPTION OF THE DRAWINGS

The invention will be described with reference to the accompanying drawings, wherein like numbers reference like elements.

FIG. 1 is a view illustrating an example of a configuration of a robot according to an embodiment.

FIG. 2 is an exploded perspective view illustrating an example of a configuration of an encoder.

FIG. 3 is an exploded perspective view illustrating the encoder in FIG. 2 as seen from a different angle.

FIG. 4 is an exploded side view of the encoder in FIG. 2.

FIG. 5 is an exploded side view illustrating the encoder in FIG. 4 as seen from a different side.

FIG. 6 is a sectional view of the encoder pertaining to a case where the encoder in FIG. 4 has been assembled.

FIG. 7 is a view illustrating an example of a side surface of a driving unit.

FIG. 8 is a view illustrating an example of the appearance of the driving unit provided in the robot.

FIG. 9 is a view illustrating an example of a section of the driving unit pertaining to a case where the driving unit is cut along a plane including a driving shaft of the driving unit in FIG. 8.

FIG. 10 is a view illustrating an example of a section of a driving unit pertaining to a case where the driving unit is cut along a plane including a driving shaft of the driving unit.

### DESCRIPTION OF EXEMPLARY EMBODIMENTS

### Embodiment

Hereinafter, an embodiment of the invention will be described with reference to drawings.

### Configuration of Robot

First, a configuration of a robot 1 will be described.

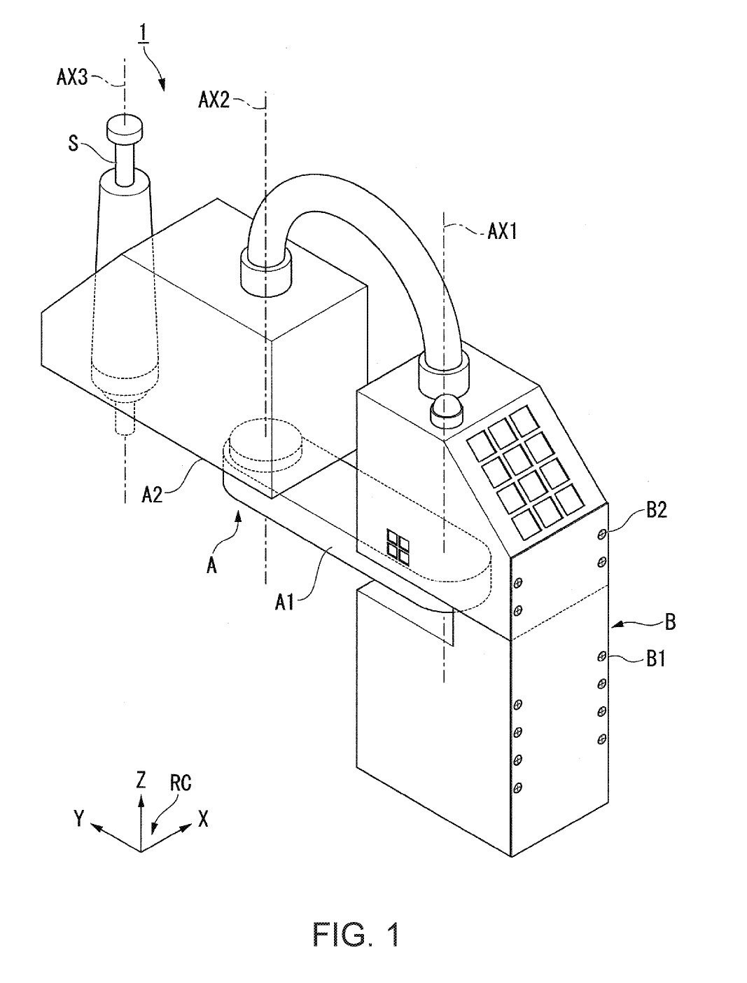

FIG. 1 is a view illustrating an example of a configuration of the robot 1 according to the embodiment. The robot 1 is a SCARA robot (horizontal articulated robot). The robot 1 may be other type of robot such as a vertical articulated robot or a cartesian coordinate robot instead of the SCARA robot. In addition, the vertical articulated robot may be a single arm robot which is provided with one arm, a two-arm robot which is provided with two arms (a multiple arm robot which is provided with two arms), or a multiple arm robot which is provided with three or more arms. In addition, the cartesian coordinate robot is, for example, a gantry robot.

The robot 1 is provided with a supporting table B that is installed on an installation surface such as a floor or a wall and a movable unit A that is supported by the supporting table B.

The supporting table B is provided with two portions. One of the portions is a base B1 and the other of the portions is a first casing B2. A space inside the base B1 is connected with a space inside the first casing B2.

The base B1 is installed on the installation surface such as a floor or a wall. The outer shape of the base B1 is a substantially rectangular parallelepiped-like shape (or a cube-like shape) and the base B1 has a hollow shape being configured of plate-shaped surfaces. The first casing B2 is fixed to a first upper surface, which is a portion of an upper surface of the base B1. The upper surface is one of surfaces of the base B1 that is opposite to the installation surface. In addition, a distance between a second upper surface, which is a portion of the upper surface of the base B1 other than the first upper surface, and the installation surface is shorter than a distance between the first upper surface and the installation surface. Accordingly, a gap is present between the second upper surface and the first casing B2. In addition, the movable unit A is provided on the second upper surface. That is, the base B1 supports the movable unit A (for example, the arm). The shape of the base B1 may be another shape instead of the above-described shape as long as the first casing B2 can be fixed to a portion of the upper surface of the base B1.

The outer shape of the first casing B2 is a shape that is obtained when cutting a rectangular parallelepiped (or a cube) in a direction perpendicular to two surfaces that constitute the rectangular parallelepiped (or the cube) and face each other such that a triangular portion including one vertex of each of the two surfaces is removed. Here, the shape obtained by cutting the portion may not be achieved by a process of cutting the portion and may be achieved by a process of forming a shape as described above in the first step. The shape of the first casing B2 is a polyhedron-like shape as described above and the first casing B2 has a hollow shape being configured of plate-shaped surfaces. The shape of the first casing B2 may be another shape instead of the above-described shape as long as the first casing B2 can be fixed to a portion of the upper surface of the base B1.

The movable unit A is provided with a first arm A1 that is supported by the supporting table B such that the first arm A1 can rotate around a first rotation axis AX1, a second arm A2 that is supported by the first arm A1 such that the second arm A2 can rotate around a second rotation axis AX2, and a shaft S that is supported by the second arm A2 such that the shaft S can rotate around a third rotation axis AX3 and can perform translational motion in an axial direction of the third rotation axis AX3.

The shaft S is a columnar shaft. A ball screw groove and a spline groove (which are not shown) are formed on a circumferential surface of the shaft S. In this example, the shaft S is provided to penetrate one of end portions of the second arm A2 that is on a side opposite to the first arm A1 side in a first direction, which is a direction in which the supporting table B is installed on the installation surface and which is a direction perpendicular to the installation surface. In addition, an end effector can be attached to one of the end portions of the shaft S that is on the installation surface side. The end effector may be an end effector that can grip an object, an end effector that can adsorb an object via air or magnetism, or another type of end effector.

In this example, the first arm A1 rotates around the first rotation axis AX1 and moves in a second direction. The second direction is a direction that is orthogonal to the first direction described above. The second direction is a direction along an XY plane in the world coordinate system or a robot coordinate system RC. The first arm A1 is rotated (driven) around the first rotation axis AX1 by a driving unit 21 (not shown) provided in the supporting table B. The driving unit 21 is provided with a motor 31 and an amplifier unit A31 (for example, the amplifier) including a drive circuit for driving the motor 31. That is, in this example, the first rotation axis AX1 is an axis that coincides with a driving shaft of the motor 31. The first rotation axis AX1 and the driving shaft of the motor 31 may not coincide with each other. In this case, for example, the motor 31 rotates the first arm A1 around the first rotation axis AX1 via a method of using a pulley and a belt. The driving unit 21 will be described later in detail.

In this example, the second arm A2 rotates around the second rotation axis AX2 and moves in the second direction. The second arm A2 is rotated around the second rotation axis AX2 by a driving unit 22 (not shown) provided in the second arm A2. The driving unit 22 is provided with a motor 32 and an amplifier unit A32 including a drive circuit for driving the motor 32. That is, in this example, the second rotation axis AX2 is an axis that coincides with a driving shaft of the motor 32. The second rotation axis AX2 and the driving shaft of the motor 32 may not coincide with each other. In this case, for example, the motor 32 rotates the second arm A2 around the second rotation axis AX2 via a method of using a pulley and a belt. The driving unit 22 will be described later in detail. In addition, the second arm A2 is provided with a driving unit 23 and a driving unit 24 (which are not shown) and supports the shaft S. The driving unit 23 is provided with a motor 33 and an amplifier unit A33 including a drive circuit for driving the motor 33. The driving unit 24 is provided with a motor 34 and an amplifier unit A34 including a drive circuit for driving the motor 34. The driving unit 23 and the driving unit 24 will be described later in detail. The motor 33 provided in the driving unit 23 moves (lifts and lowers) the shaft S in the first direction by rotating a ball screw nut provided on an outer circumferential portion of the ball screw groove of the shaft S by using a timing belt or the like. The motor 34 of the driving unit 24 rotates the shaft S around the third rotation axis AX3 by rotating a ball spline nut provided on an outer circumferential portion of the spline groove of the shaft S by using a timing belt or the like.

Hereinafter, as an example, a case where the driving units 21 to 24 have the same configuration will be described. That is, in this example, the motors 31 to 34 have the same configuration and the amplifier units A31 to A34 have the same configuration. A portion or all of the driving units 21 to 24 may be different in configuration thereof. In addition, a portion or all of the amplifier units A31 to A34 may be different in configuration thereof.

Therefore, hereinafter, the driving units 21 to 24 will be collectively referred to as a driving unit 2 if there is no need to distinguish between the driving units 21 to 24. In addition, hereinafter, the motors 31 to 34 will be collectively referred to as a motor 3 if there is no need to distinguish between the motors 31 to 34. In addition, hereinafter, the amplifier units A31 to A34 will be collectively referred to as an amplifier unit A3 if there is no need to distinguish between the amplifier units A31 to A34. In addition, hereinafter, the expression “the driving shaft of the motor 3” means not only the driving shaft of the motor 3 but also a virtual axis extending from the driving shaft.

The motor 3 is provided with an encoder 4 that outputs a rotation angle of the driving shaft of the motor 3 to a robot control device or other devices. The robot control device is a control device that controls the robot 1, that is, a control device that controls the first arm A1, the second arm A2, and the shaft S. The robot control device may be built into the robot 1 and may be a separate component externally attached to the robot 1. Hereinafter, a case where at least a portion of the robot control device is positioned in the base B1 will be described. In this case, a portion of the robot control device may be positioned in the first casing B2 and the entire robot control device may be positioned in the base B1. In a case where the robot control device is a separate component externally attached to the robot 1, the robot control device is connected to the robot 1 such that the robot control device and the robot 1 can communicate with each other in a wired manner or a wireless manner.

### Configuration of Encoder

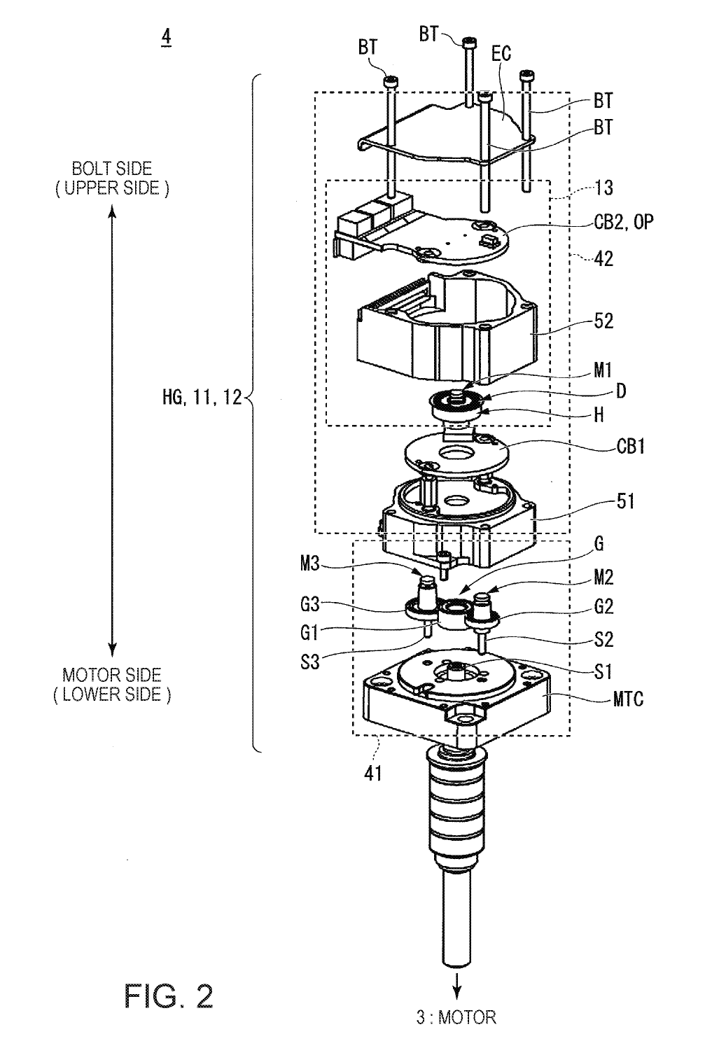

Hereinafter, a configuration of the encoder 4 will be described with reference to FIGS. 2 to 6.

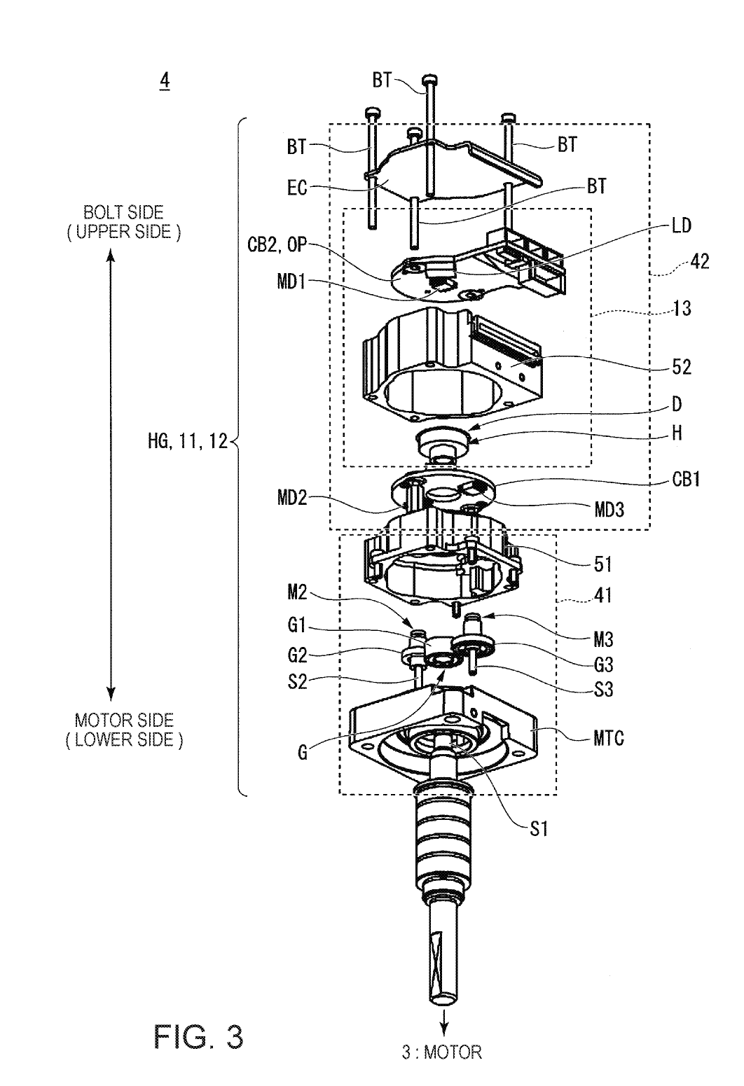

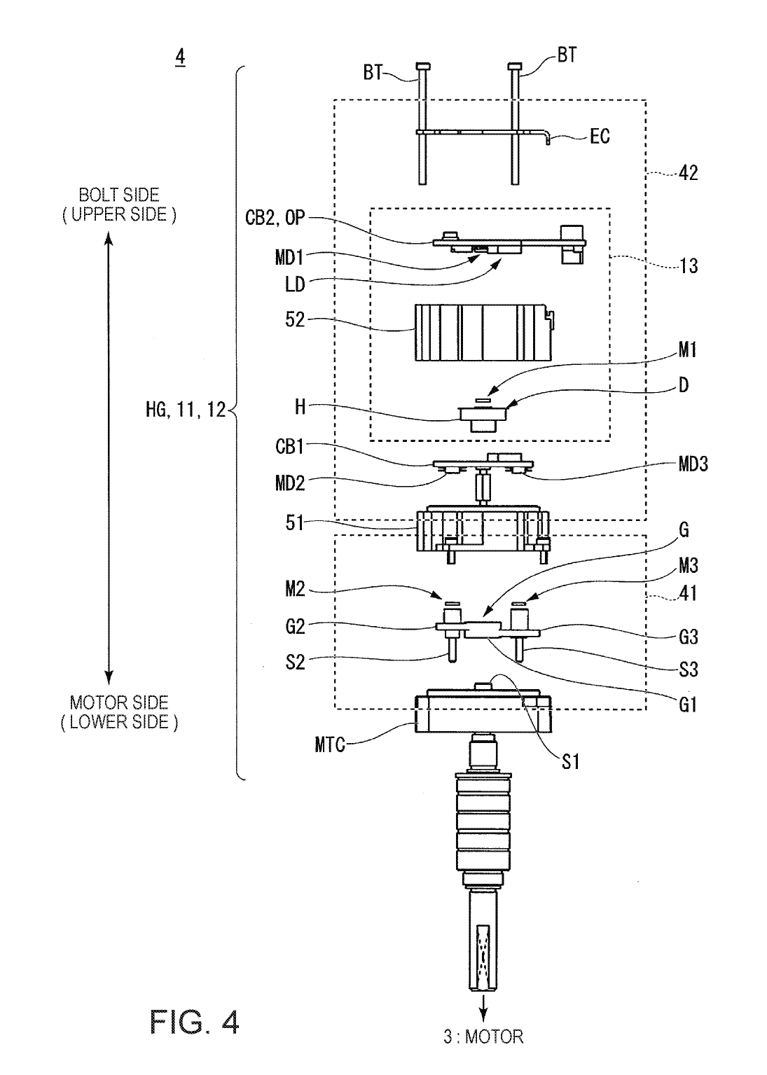

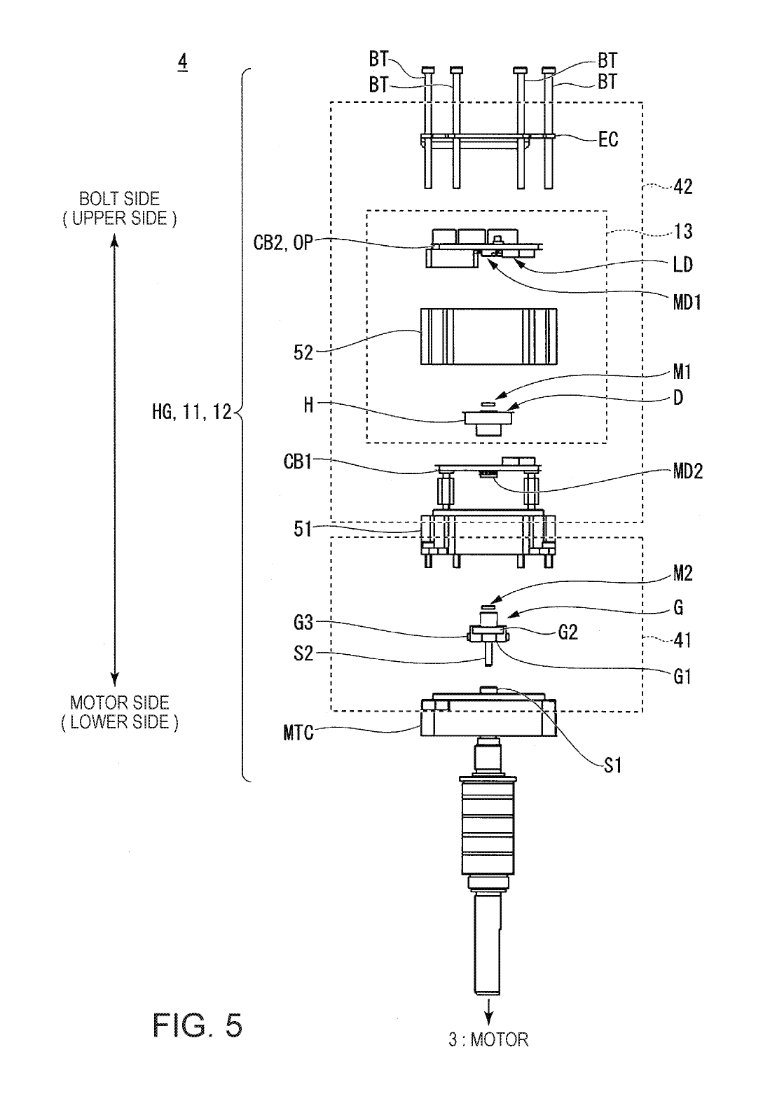

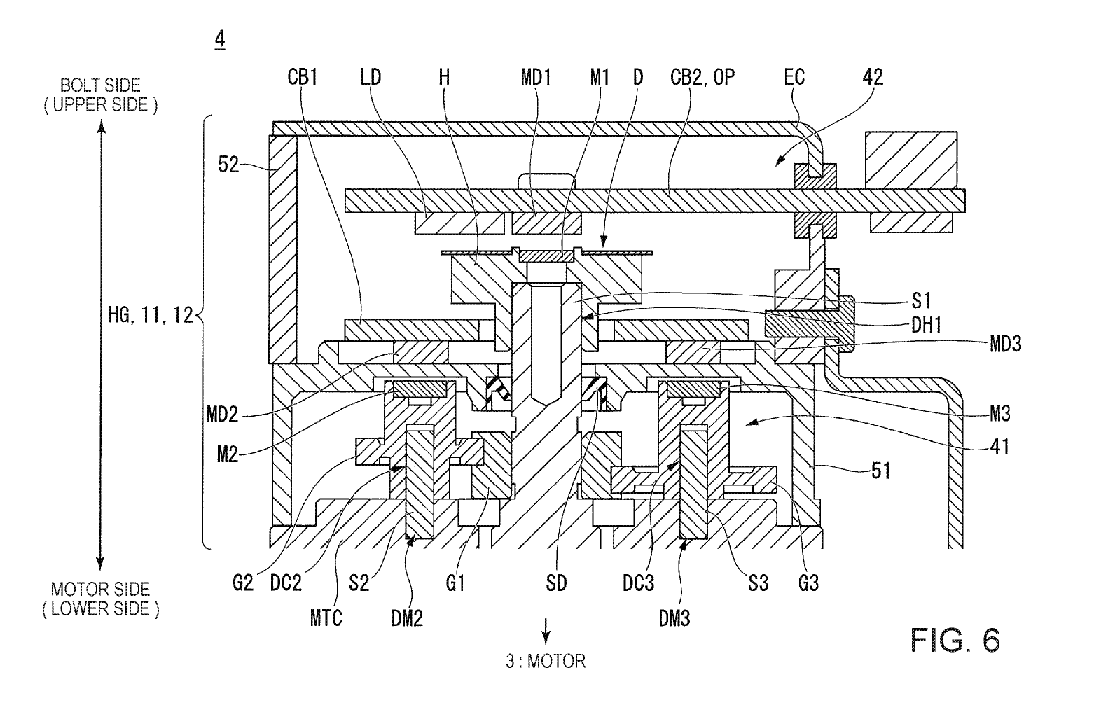

FIG. 2 is an exploded perspective view illustrating an example of a configuration of the encoder 4. In addition, FIG. 3 is an exploded perspective view illustrating the encoder 4 in FIG. 2 as seen from a different angle. In addition, FIG. 4 is an exploded side view of the encoder 4 in FIG. 2. In addition, FIG. 5 is an exploded side view illustrating the encoder 4 in FIG. 4 as seen from a different side. In addition, FIG. 6 is a sectional view of the encoder 4 pertaining to a case where the encoder 4 in FIG. 4 has been assembled. In FIGS. 2 to 6, only main components constituting the encoder 4 are shown and some components are not shown.

As illustrated in FIGS. 2 to 6, the encoder 4 has a configuration in which a first position detector 11 and a second position detector 12 are stored in a housing HG. The first position detector 11 is a magnetic encoder device including a gear. The second position detector 12 is an optical encoder device including an optical detector 13. The housing HG is configured of two storage portions of a first storage portion 41 and a second storage portion 42. The housing HG has a configuration in which a gear unit G is stored in the first storage portion 41 and a magnetic substrate CB1, a seat H on which an optical disk D is provided, and a control substrate CB2 are stored in the second storage portion 42.

The first storage portion 41 is configured of a motor top case MTC that constitutes a partition wall portion in the first storage portion 41 and a first casing 51 that is fixed to the motor top case MTC. In addition, the first casing 51 is a molded body that is integrally molded using insulating resin and the first casing 51 is fixed to the motor top case MTC via bolts BT. Therefore, in the encoder 4, heat transmission from an object (in this example, the motor 3), from which heat is transmitted to the encoder 4, to the optical detector 13 is suppressed and thus thermal expansion of the optical detector 13 can be suppressed. In this example, the material of the first casing 51 is polyacetal (POM). However, the material may be other resin instead of the polyacetal.

The motor top case MTC is a member that constitutes one end portion of end portions of the motor 3 in an axial direction of a first shaft S1, the one end portion being on the encoder 4 side. The first shaft S1 is a shaft that is provided in the motor 3 as the driving shaft of the motor 3. In FIGS. 2 to 6, only two of components constituting the motor 3 (the motor top case MTC and the first shaft S1) are shown and other components are not shown. Hereinafter, for convenience of explanation, one of the axial directions of the first shaft S1 that is a direction from the encoder 4 to the motor 3 will be referred to as a downward direction and the other one of the axial directions of the first shaft S1 that is a direction from the motor 3 to the encoder 4 will be referred to as an upward direction.

The second storage portion 42 is configured of an upper end portion of the first casing 51 that constitutes a partition wall portion in the second storage portion 42, a second casing 52 that is fixed to the upper end portion, and a lid member EC. The second casing 52 is a molded body that is integrally molded using conductive metal and is fixed to the upper end portion via the bolts BT. In addition, the lid member EC is fixed to the second casing 52 via the bolts BT.

Here, a configuration of the housing HG will be briefly summarized. Regarding the housing HG, the lid member EC, the second casing 52, the first casing 51, and the motor top case MTC are assembled being arranged in this order in a direction from the upper side to the lower side and the housing HG is fixed with the bolts BT (in this example, four bolts BT) inserted into the lid member EC, the second casing 52, the first casing 51, and the motor top case MTC in this order in the direction from the upper side to the lower side. In addition, in the second storage portion 42, the control substrate CB2, the seat H, and the magnetic substrate CB1 are stored in the order of the control substrate CB2, the seat H, and the magnetic substrate CB1 in the direction from the upper side to the lower side.

A portion of a plurality of members that the first position detector 11 includes is stored in the first storage portion 41 and a member other than the portion of the plurality of members is stored in the second storage portion 42. Specifically, the first position detector 11 includes the gear unit G, the first shaft S1, a first magnet M1, a first magnetic flux detecting element MD1, a second shaft S2, a second magnet M2, a second magnetic flux detecting element MD2, a third shaft S3, a third magnet M3, a third magnetic flux detecting element MD3, the magnetic substrate CB1, and the control substrate CB2.

The gear unit G includes three gears with different numbers of teeth and different diameters, the three gears being a first gear G1, a second gear G2, and a third gear G3. The first gear G1 is a gear that is connected (fixed) to the first shaft S1 and rotates along with the first shaft S1. That is, in this example, a shaft that serves as a rotation shaft of the first gear G1 is the first shaft S1. Accordingly, it is not necessary that the first shaft S1 in the encoder 4 is provided with a shaft that is separated from the first shaft S1 and serves as the rotation shaft of the first gear G1 and thus it is possible to suppress assembly deviation between the first shaft S1 and the shaft which occurs due to vibration or the like. Each of the second gear G2 and the third gear G3 is a gear that meshes with the first gear G1. In addition, the second gear G2 and the third gear G3 do not mesh with each other. In addition, in this example, when the encoder 4 is seen from a direction orthogonal to a vertical direction, the rotation shafts of the first gear G1, the second gear G2, and the third gear G3 are arranged in a line in the order of the second gear G2, the first gear G1, and the third gear G3. Note that, in this case, the rotation shafts of the first gear G1, the second gear G2, and the third gear G3 may not be arranged in a line as long as the second gear G2 and the third gear G3 mesh with the first gear Gland the second gear G2 and the third gear G3 do not mesh with each other.

The first magnet M1 is a magnet provided on the first shaft S1. The first magnet M1 may be provided on the first shaft S1 via no any other member and may be provided on the first shaft S1 via another member. In an example illustrated in FIGS. 2 to 6, the first magnet M1 is provided on an upper end portion of the first shaft S1 via the seat H as the other member. The first magnet M1 is a permanent magnet, for example, a samarium cobalt magnet. The first magnet M1 may be another magnet such as a neodymium magnet instead of the samarium cobalt magnet. The first magnetic flux detecting element MD1 is a magnetic flux detecting element that detects a magnetic flux from the first magnet M1 and is configured with a hall element that outputs a signal indicating the detected magnetic flux.

As illustrated in FIG. 6, the second shaft S2 is a shaft that is inserted into a recess portion DC2 of the second gear G2 that is processed as a slide bearing including the recess portion DC2. Therefore, the second gear G2 rotates around the second shaft S2 by using the second shaft S2 as a rotation axis with approximately no load. In addition, the second shaft S2 is inserted into a recess portion DM2 formed in the motor top case MTC, that is, in the casing of the motor 3. Therefore, the encoder 4 does not need to include another member into which the second shaft S2 is inserted and thus it is possible to reduce the size of the encoder 4 in an axial direction of the second shaft S2. In addition, the second shaft S2 is inserted into the second gear G2 without penetrating the second gear G2. The second magnet M2 is a magnet provided on an upper end portion of the second gear G2. The second magnet M2 is a permanent magnet, for example, a samarium cobalt magnet. The second magnet M2 may be another magnet such as a neodymium magnet instead of the samarium cobalt magnet. The second magnetic flux detecting element MD2 is a magnetic flux detecting element that detects a magnetic flux from the second magnet M2 and is configured with a hall element that outputs a signal indicating the detected magnetic flux.

As illustrated in FIG. 6, the third shaft S3 is a shaft that is inserted into a recess portion DC3 of the third gear G3 that is processed as a slide bearing including the recess portion DC3. Therefore, the third gear G3 rotates around the third shaft S3 by using the third shaft S3 as a rotation axis with approximately no load. In addition, the third shaft S3 is inserted into a recess portion DM3 formed in the motor top case MTC, that is, in the casing of the motor 3. Therefore, the encoder 4 does not need to include another member into which the third shaft S3 is inserted and thus it is possible to reduce the size of the encoder 4 in an axial direction of the third shaft S3. In addition, the third shaft S3 is inserted into the third gear G3 without penetrating the third gear G3. The third magnet M3 is a magnet provided on an upper end portion of the third gear G3. The third magnet M3 is a permanent magnet and is a for example, a samarium cobalt magnet. The third magnet M3 may be another magnet such as a neodymium magnet instead of the samarium cobalt magnet. The third magnetic flux detecting element MD3 is a magnetic flux detecting element that detects a magnetic flux from the third magnet M3 and is configured with a hall element that outputs a signal indicating the detected magnetic flux.

The magnetic substrate CB1 is a substrate provided with the second magnetic flux detecting element MD2 and the third magnetic flux detecting element MD3. The magnetic substrate CB1 may be a substrate obtained by assembling two or more parts of the substrate.

The control substrate CB2 is a substrate provided with the first magnetic flux detecting element MD1. In addition, the control substrate CB2 includes a control circuit that controls the motor 3 to constitute a computing unit OP. That is, in this example, the computing unit OP is provided in an area axially above the driving shaft of the motor 3. Here, the area axially above the driving shaft of the motor 3 means an area that overlaps with the first shaft S1 of the motor 3 when the motor 3 is seen in a direction along the driving shaft of the motor 3. Specifically, the control circuit of the computing unit OP obtains information indicating a rotation angle at which the driving shaft of the motor 3 is rotated from the above-described robot control device, converts the information into a voltage waveform for rotating the driving shaft at the rotation angle indicated by the obtained information, and supplies a control signal corresponding to the voltage waveform obtained through the conversion to the amplifier unit A3 to cause the amplifier unit A3 to control the motor 3. That is, the drive circuit of the amplifier unit A3 obtains the control signal corresponding to the voltage waveform calculated by the control circuit of the computing unit OP from the computing unit OP and causes the driving shaft of the motor 3 to rotate based on the obtained control signal. In addition, the control substrate CB2 supplies power, which is supplied from a power source (not shown) via a power line connected to the control substrate CB2, to the amplifier unit A3. The control substrate CB2 may be a substrate obtained by assembling two or more parts of the substrate. In addition, the control substrate CB2 and the computing unit OP may be configured as separated components. In this case, the computing unit OP may be positioned inside the encoder 4 and may be positioned outside the encoder 4. In addition, in this case, if the computing unit OP is positioned inside the encoder 4, the computing unit OP may be positioned axially above the driving shaft of the motor 3 and may not be positioned axially above the driving shaft.

The first position detector 11 detects the angular position of the first shaft S1 (or the first gear G1 that rotates along with the first shaft S1) based on a magnetic flux from the first magnet M1 that is detected by the first magnetic flux detecting element MD1. In addition, the first position detector 11 detects the angular position of the second gear G2 based on a magnetic flux from the second magnet M2 that is detected by the second magnetic flux detecting element MD2. In addition, the first position detector 11 detects the angular position of the third gear G3 based on a magnetic flux from the third magnet M3 that is detected by the third magnetic flux detecting element MD3.

Here, in the first position detector 11, the first casing 51 includes a first portion P1 that is positioned between the second magnet M2 and the second magnetic flux detecting element MD2. Specifically, as illustrated in FIG. 6, the second magnet M2 and the second magnetic flux detecting element MD2 face each other with a portion of the upper end portion of the first casing 51 (that is, the first portion P1) interposed therebetween. Therefore, according to the encoder 4, it is possible to suppress a change in relative distance between the second magnet M2 and the second magnetic flux detecting element MD2 in the vertical direction. As a result, according to the encoder 4, it is possible to suppress error in detecting the angular position of the second gear G2 based on such a change in distance.

In addition, in the first position detector 11, the first casing 51 includes a second portion P2 that is positioned between the third magnet M3 and the third magnetic flux detecting element MD3. Specifically, as illustrated in FIG. 6, the third magnet M3 and the third magnetic flux detecting element MD3 face each other with a portion of the upper end portion of the first casing 51 (that is, the second portion P2) interposed therebetween. Therefore, according to the encoder 4, it is possible to suppress a change in relative distance between the third magnet M3 and the third magnetic flux detecting element MD3 in the vertical direction. As a result, according to the encoder 4, it is possible to suppress error in detecting the angular position of the third gear G3 based on such a change in distance.

The second position detector 12 includes the optical detector 13 and detects the angular position of the first shaft S1 by using light. The optical detector 13 includes the seat H fixed to the first shaft S1, the optical disk D provided (fixed) on an upper surface of the seat H, an optical element LD provided (fixed) on the control substrate CB2, and a light emitting element (not shown).

A plurality of slit rows, each of which is constituted of a plurality of slits arranged in a circumferential direction, are formed on the optical disk D. Here, the second position detector 12 has a known configuration and thus the description thereof will be omitted. As described above, in this example, the optical disk D is disposed between the magnetic substrate CB1 and the control substrate CB2. The magnetic substrate CB1 and the control substrate CB2 are electrically connected to each other via an electrical connecting member (not shown). In addition, the slits on the optical disk D are, for example, reflecting slits. However, the slits may be transmitting slits instead of the reflecting slits. In a case where the slits on the optical disk D are transmitting slits, the optical detector 13 is provided to be positioned such that the optical detector 13 can detect light passing through the optical disk D.

In addition, as illustrated in FIG. 6, the first shaft S1 penetrates an upper end portion of the motor top case MTC, the first gear G1, the upper end portion of the first casing 51, and the magnetic substrate CB1 in this order in a direction from a lower portion to an upper portion of the motor top case MTC. That is, through-holes through which the first shaft S1 passes in a direction from the lower side to the upper side are respectively formed in the upper end portion of the motor top case MTC, the first gear G1, the upper end portion of the first casing 51, and the magnetic substrate CB1.

The first casing 51 in the encoder 4 as described above separates the first to third gears G1 to G3, which are gears that the gear unit G includes, from the optical detector 13 via a sealing portion SD (for example, the seal), as described above. This is for restraining grease that is applied to the gears stored in the first storage portion 41 or dust such as wear debris between the first gear G1 and the second gear G2 or the third gear G3 out of the gears from adhering to an object included inside the second storage portion 42. The sealing portion SD is, for example, an oil seal. The sealing portion SD may be another sealing member such as a gasket, packing, or a waterproof seal instead of the oil seal. According to the encoder 4 including the sealing portion SD, it is possible to reduce the size of the sealing portion SD in comparison with an encoder that includes a bearing as the sealing portion SD instead of the oil seal and thus it is possible to achieve reduction in size while separating the gears from the optical detector 13 via the sealing portion SD.

In an example illustrated in FIG. 6, the sealing portion SD is positioned between the first shaft S1 and the first casing 51. Specifically, the sealing portion SD is positioned between a through-hole through which the first shaft S1 penetrates the first casing 51 and the first shaft S1. Therefore, in the encoder 4, the gears of the gear unit G and the optical detector 13 can be separated from each other by the sealing portion SD positioned between the first shaft S1 and the first casing 51. In addition, in this example, the sealing portion SD is positioned on the same plane as the second magnet M2 and the third magnet M3. The plane is a plane orthogonal to the vertical direction. In other words, the sealing portion SD has a portion that overlaps with both of the second magnet M2 and the third magnet M3 when the encoder 4 is seen in a direction from the second magnet M2 toward the third magnet M3, the direction being orthogonal to the vertical direction. Therefore, in the encoder 4, the gears of the gear unit G and the optical detector 13 can be separated from each other by the sealing portion SD positioned on the same plane as the second magnet M2 and the third magnet M3. The sealing portion SD may be positioned on the same plane as only one of the second magnet M2 and the third magnet M3. In this case, in the encoder 4, the gears of the gear unit G and the optical detector 13 can be separated from each other by the sealing portion SD positioned on the same plane as only one of the second magnet M2 and the third magnet M3.

Here, in the encoder 4, the first position detector 11 detects the angular positions (multi-rotation data) of the first to third gears G1 to G3 and the second position detector 12 detects the angular position of the first shaft S1 (or the first gear G1) for one time of rotation. Therefore, the encoder 4 can detect the absolute position of the first shaft S1 based on the detected angular positions.

In addition, in the first position detector 11 of the encoder 4, since the first to third gears G1 to G3 have different numbers of teeth and different diameters, the first to third gears G1 to G3 are different from each other in rotation ratio. Accordingly, the first position detector 11 can detect the angular positions of the first to third gears G1 to G3 and can calculate multi-rotation data based on the detected angular positions. Therefore, the first position detector 11 does not need to include a member for storing multi-rotation data. As a result, the first position detector 11 does not need to include a battery supplying power that drives a member for storing (holding) multi-rotation data. That is, according to the encoder 4, it is possible to achieve reduction in size while separating the gears of the gear unit G from the optical detector 13 via the sealing portion SD and it is possible to achieve reduction in size corresponding to the volume of the battery. Such a configuration is effective in further reduction in size of the motor 3 that is provided with the encoder 4 and the robot 1 that is provided with the motor 3. The encoder 4 is an example of an angle detector.

### Configuration of Driving Unit

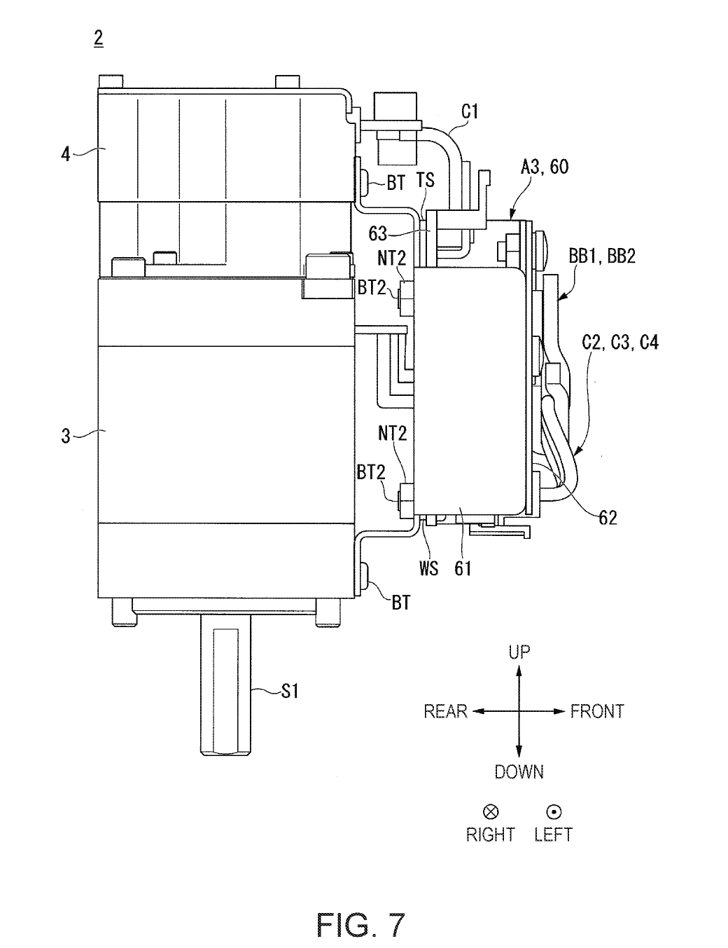

Hereinafter, a configuration of the driving unit 2 will be described with reference to FIG. 7. FIG. 7 is a view illustrating an example of a side surface of the driving unit 2. The driving unit 2 is provided with the motor 3 and the amplifier unit A3, as described above.

The motor 3 is, for example, a three-phase DC motor. The motor 3 may be another type of motor instead of the three-phase DC motor. The amplifier unit A3 amplifies power supplied via the control substrate CB2 provided in the encoder 4 and drives the motor 3 according to a control signal supplied from the control substrate CB2. More specifically, when the motor 3 is driven, the amplifier unit A3 supplies power to an electromagnet for each of three phases, which the motor 3 includes, at a time corresponding to the control signal. In the following description, each of the three phases will be referred to as a U-phase, a V-phase, and a W-phase, for convenience of explanation.

The amplifier unit A3 supplies power to a U-phase electromagnet of the motor 3 via a power line C2. That is, the power line C2 is a power line that connects the amplifier unit A3 and the U-phase electromagnet of the motor 3 to each other. The amplifier unit A3 supplies power to a V-phase electromagnet of the motor 3 via a power line C3. That is, the power line C3 is a power line that connects the amplifier unit A3 and the V-phase electromagnet of the motor 3 to each other. The amplifier unit A3 supplies power to a W-phase electromagnet of the motor 3 via a power line C4. That is, the power line C4 is a power line that connects the amplifier unit A3 and the W-phase electromagnet of the motor 3 to each other.

In addition, power from the above-described control substrate CB2 is supplied to the amplifier unit A3 via a power line that extends in a pipe C1. As described above, power from the power source (not shown) is supplied to the control substrate CB2 and the supplied power is supplied to the amplifier unit A3 via the power line. In addition, a control signal from the control substrate CB2 is supplied to the amplifier unit A3 via a communication line that extends in the pipe C1. The computing unit OP of the control substrate CB2 obtains information indicating a rotation angle at which the driving shaft of the motor 3 is rotated from the above-described robot control device, converts the information into a voltage waveform for rotating the driving shaft at the rotation angle indicated by the obtained information, and supplies a control signal corresponding to the voltage waveform obtained through the conversion to the amplifier unit A3 via the communication line.

The amplifier unit A3 has a configuration in which an amplifier substrate 63 is stored in a storage portion 60. The amplifier substrate 63 is a substrate that includes the above-described drive circuit and a communication circuit. In this example, the storage portion 60 is configured of a heat dissipation member 61 that constitutes a rear partition wall portion of the storage portion 60, a left partition wall portion of the storage portion 60, and a right partition wall portion of the storage portion 60 and an amplifier cover 62 that is fixed to the heat dissipation member 61 and the storage portion 60 does not include an upper partition wall portion and a lower partition wall portion. The amplifier substrate 63 of the storage portion 60 is disposed (fixed) on the rear partition wall portion of the storage portion 60. Since the storage portion 60 does not include the upper partition wall portion and the lower partition wall portion, the storage portion 60 can dissipate heat of the amplifier unit A3 (that is, heat from the amplifier substrate 63) via air passing through the storage portion 60.

The heat dissipation member 61 includes an attachment portion that can be attached to a side surface of the motor 3 via bolts BT. Therefore, the motor 3 and the amplifier unit A3 of the driving unit 2 can be integrated with each other. Through-holes through which the bolts BT pass are formed in the attachment portion. In an example illustrated in FIG. 7, the heat dissipation member 61 is attached to the side surface of the motor 3 via the attachment portion and four bolts BT. The heat dissipation member 61 may be attached to the side surface of the motor 3 via an attachment jig or an attachment mechanism other than the bolts BT instead of being attached to the side surface of the motor 3 via the bolts BT.

The amplifier substrate 63 is disposed (fixed) on the heat dissipation member 61 via a bolt BT2 and a nut NT2. A shock absorbing member WS is interposed between the amplifier substrate 63 and the heat dissipation member 61. The shock absorbing member WS is a member for suppressing deformation of the amplifier substrate 63 which is caused by a stress generated due to a bolt fastened when the amplifier substrate 63 is disposed on the heat dissipation member 61 and the shock absorbing member WS is, for example, a spring washer. Therefore, according to the driving unit 2, it is possible to suppress deformation of the amplifier substrate 63 which occurs when the heat dissipation member 61 is attached to the amplifier substrate 63. The shock absorbing member WS may be another member that suppresses the deformation of the amplifier substrate 63, which is caused by the stress, instead of the spring washer.

In addition, a heat dissipation sheet TS is interposed in at least a portion of an area between the amplifier substrate 63 and the heat dissipation member 61. The thickness of the heat dissipation sheet TS (in this example, the thickness in a front-rear direction) is substantially the same as the thickness of the shock absorbing member WS (in this example, the thickness in the front-rear direction) pertaining to a state where the amplifier substrate 63 is disposed on the heat dissipation member 61 via the bolt BT2 and the nut NT2. The above-described portion is a portion of the area between the amplifier substrate 63 and the heat dissipation member 61 of which the temperature rises when the amplifier substrate 63 generates heat. In addition, the heat dissipation sheet TS is formed not to have a portion that overlaps with the shock absorbing member WS when the amplifier unit A3 is seen in a direction from the front side to the rear side. Therefore, according to the driving unit 2, it is possible to fill a gap between the amplifier substrate 63 and the heat dissipation member 61 which is caused by the shock absorbing member WS interposed therebetween and it is possible to suppress failure caused by heat generation of the amplifier unit A3.

The amplifier cover 62 is a cover that covers a front surface of the storage portion 60. The above-described power line C2, the power line C3, and the power line C4 are bound to the amplifier cover 62. Therefore, according to the driving unit 2, it is possible to suppress interference between each of the power line C2, the power line C3, and the power line C4 and another object. A position to which each of the power line C2, the power line C3, and the power line C4 is bound may be another position instead of the position illustrated in FIG. 7.

Here, in a case where the amplifier unit A3 is attached to the side surface of the motor 3 via the heat dissipation member 61, the motor 3 is provided with the amplifier substrate 63 such that the amplifier substrate 63 becomes parallel to the driving shaft of the motor 3 as illustrated in FIG. 7. More specifically, in this case, a portion of the motor 3 and a portion of the amplifier substrate 63 do not overlap with each other when the motor 3 and the amplifier unit A3 are seen in the direction along the driving shaft of the motor 3. Therefore, in the robot 1, it is possible to reduce the length of a member, which is obtained by assembling the motor 3 and the amplifier unit A3, in the direction along the driving shaft of the motor 3 corresponding to the length of the amplifier substrate 63 with which the motor 3 is provided such that the amplifier substrate 63 becomes parallel to the driving shaft of the motor 3. For example, in a case where the thickness of the amplifier substrate 63 is approximately 20 mm, in the robot 1, it is possible to reduce the length of the member by approximately 20 mm.

In the robot 1, in each of the three driving units of the driving units 22 to 24, the amplifier unit A3 is attached to the side surface of the motor 3 via the heat dissipation member 61 as illustrated in FIG. 7. Meanwhile, in the driving unit 21, the amplifier unit A31 is disposed on an inner wall of the supporting table B in which the driving unit 21 is installed. The driving unit 21 and the amplifier unit A31 are electrically connected to each other.

Various Objects provided for Driving Unit

Hereinafter, various objects provided for the driving unit 2 will be described.

The driving unit 2 is provided with a speed reducer (not shown) that reduces the rotation speed of the driving shaft of the motor 3. The motor 3 of the driving unit 2 and the speed reducer of the driving unit 2 are positioned axially above the driving shaft of the motor 3. All or a portion of the driving units 21 to 24 may have a configuration without the speed reducer.

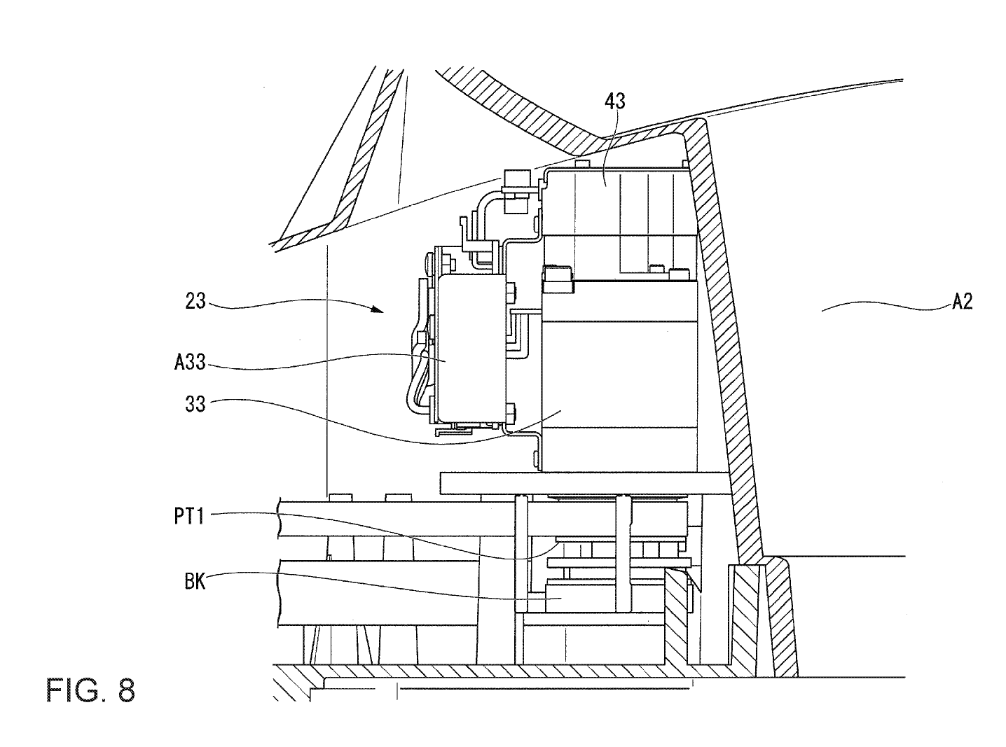

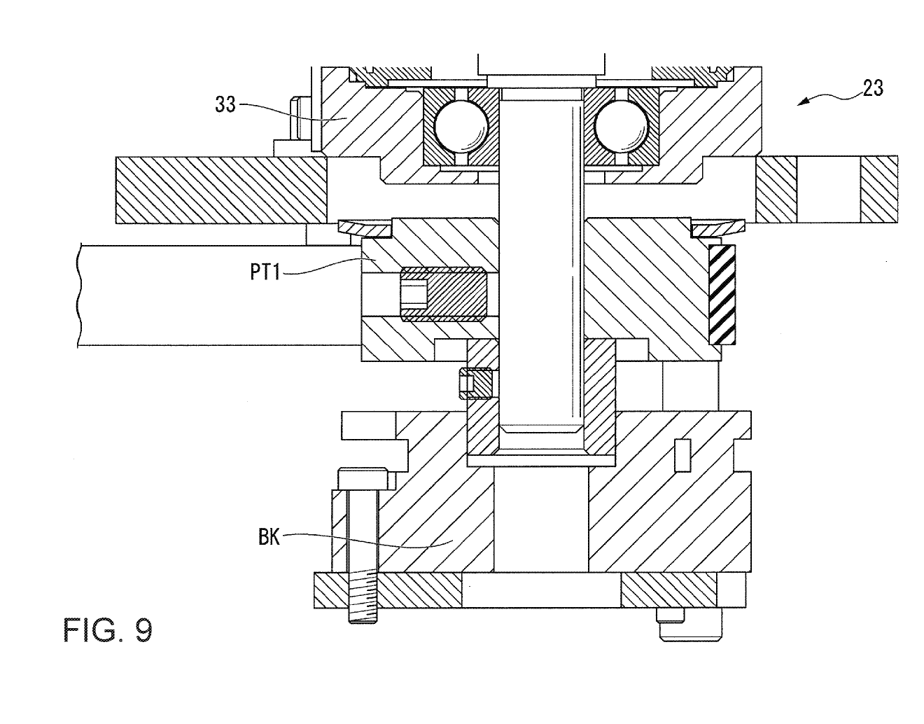

In addition, as illustrated in FIGS. 8 and 9, the driving unit 23 is provided with, for example, a braking unit BK (for example, the brake) and a pulley PT1. The braking unit BK brakes the driving shaft of the motor 33. More specifically, the braking unit BK is an electromagnetic brake that holds the driving shaft of the motor 33 such that the driving shaft does not move. FIG. 8 is a view illustrating an example of the appearance of the driving unit 23 provided in the robot 1. FIG. 9 is a view illustrating an example of a section of the driving unit 23 pertaining to a case where the driving unit 23 is cut along a plane including the driving shaft of the driving unit 23 in FIG. 8. Since the driving unit 23 is provided with the braking unit BK, according to the robot 1, it is possible to more reliably brake the driving unit 23 by using the braking unit BK in comparison with a case where a non-electromagnetic braking unit such as mechanical brake is used. Here, an encoder 43 illustrated in FIGS. 8 and 9 is an example of the encoder 4 provided in the motor 33. The braking unit BK may be another brake such as a mechanical brake that holds the driving shaft such that the driving shaft does not move. In a case where the driving unit 2 is provided with the braking unit BK as in the case of the driving unit 23, the amplifier substrate 63 of the amplifier unit A3 is provided with a circuit that controls the braking unit BK. The circuit and the braking unit BK are electrically connected to each other via a wire. The length of the wire can be reduced in a case where the amplifier unit A3 is attached to the side surface of the motor 3 as in the case of the driving unit 23. In addition, in the driving unit 23, the braking unit BK is positioned axially above the driving shaft of the motor 33. A portion or all of the driving unit 21, the driving unit 22, and the driving unit 24 may have a configuration provided with the braking unit BK as with the driving unit 23.

The pulley PT1 is a pulley that rotates in accordance with rotation of the driving shaft of the motor 33 and that rotates a timing belt that rotates the ball screw nut provided on the outer circumferential portion of the ball screw groove of the shaft S. That is, the pulley PT1 transmits a driving force of the driving shaft of the motor 33 to the timing belt. A portion or all of the driving unit 21, the driving unit 22, and the driving unit 24 may have a configuration provided with the pulley PT1 as with the driving unit 23.

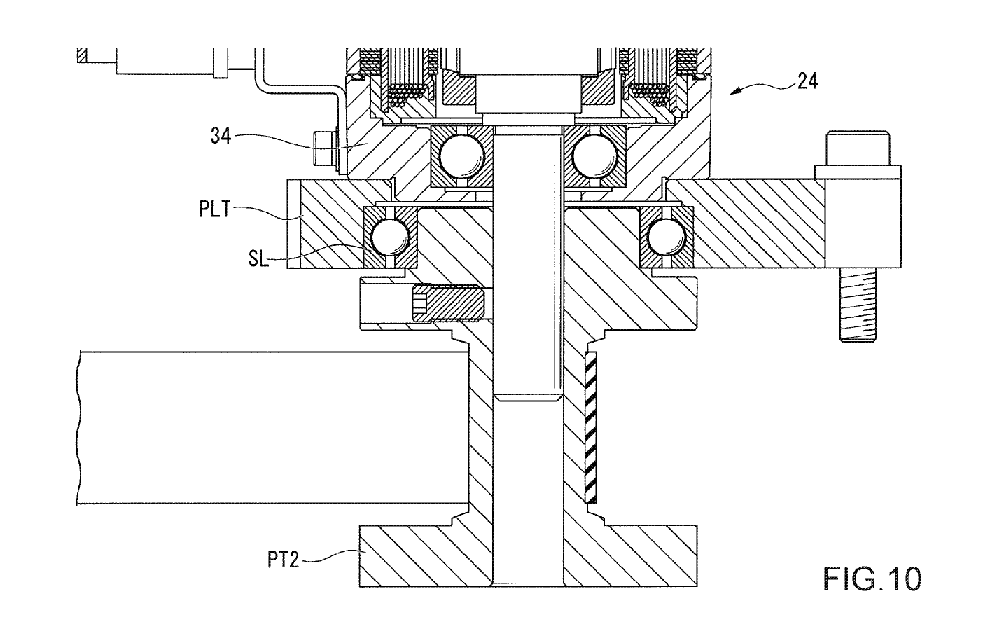

In addition, as illustrated in FIG. 10, the driving unit 24 is fixed (installed) onto a plate PLT provided inside the second arm A2 such that the driving unit 24 does not move. FIG. 10 is a view illustrating an example of a section of the driving unit 24 pertaining to a case where the driving unit 24 is cut along a plane including the driving shaft of the driving unit 24. In addition, the driving shaft of the motor 34 provided in the driving unit 24 is provided with a pulley PT2. The pulley PT2 is a pulley that rotates a timing belt that rotates the ball spline nut provided on the outer circumferential portion of the spline groove of the shaft S. In an example illustrated in FIG. 10, the driving unit 24 and the pulley PT2 face each other with the plate PLT interposed therebetween in a direction along the driving shaft of the motor 34. In addition, in this example, a first braking member SL, which is a non-electromagnetic braking member that brakes the driving unit 24 (that is, brakes rotation of the driving shaft of the motor 34), is provided between the plate PLT and the pulley PT2. In the example illustrated in FIG. 10, the first braking member SL is a braking member that includes a bearing. More specifically, the first braking member SL is a braking member that includes a bearing with an oil seal. In addition, the first braking member SL is in contact with the driving shaft of the motor 34. Accordingly, the first braking member SL brakes the driving shaft by using a frictional force that is generated at a rotating portion of the bearing. In this example, the frictional force has such a magnitude that the shaft S does not rotate (that is, the pulley PT2 does not rotate) due to the weight of an object when the shaft S (that is, the movable unit A) lifts up the object having a weight of 5 kg or less. That is, in this example, the maximum weight of an object that can be moved by the movable unit A is, 5 kg or less. If the shaft S is rotated due to the weight of the object, the shaft S falls along with the object while rotating. The first braking member SL suppresses the falling of the shaft S. Here, since the driving unit 24 is provided with the first braking member SL, it is not necessary to provide an electromagnetic brake in the driving unit 24 of the robot 1 and thus it is possible to achieve reduction in cost corresponding to the cost for an electromagnetic brake being not provided, reduction in size, and improvement in maintainability. The frictional force generated at the rotating portion of the bearing may have such a magnitude that the shaft S does not rotate due to the weight of an object when the shaft S (that is, the movable unit A) lifts up the object having a weight exceeding 5 kg. In this case, the maximum weight of an object that can be moved by the movable unit A is equal to or lower than the weight exceeding 5 kg.

The first braking member SL may be in contact with a member that moves along with the driving unit 24 (that is, a member that moves along with the driving shaft of the driving unit 24). In this case, the first braking member SL brakes rotation of the member by using a frictional force generated at the rotating portion of the bearing so as to brake rotation of the driving shaft of the driving unit 24. In addition, instead of the braking member including the bearing with the oil seal, the first braking member SL may be a braking member including a sealing member such as an oil seal molded using resin such as POM, a gasket, packing, or a waterproof seal. In addition, the first braking member SL may be a braking member that includes a sealing member such as an oil seal molded using resin such as POM, a gasket, packing, or a waterproof seal in addition to the bearing with the oil seal. In this case, the first braking member SL brakes the driving shaft by using a frictional force generated between the first braking member SL and the driving shaft of the driving unit 24. In addition, a portion or all of the driving units 21 to 23 may have a configuration provided with the pulley PT2 as with the driving unit 24. In addition, a portion or all of the driving units 21 to 23 may have a configuration provided with the first braking member SL as with the driving unit 24.

Each of the speed reducer, the pulley PT1, and the pulley PT2 in the above description is an example of a motive power transmitting unit that transmits a motive power from the driving shaft of the motor 3. In addition, the speed reducer, the pulley PT1, the pulley PT2, the computing unit OP, and the braking unit BK are an example of a first object with which the robot is provided.

As described above, in the robot 1, a motor (in this example, the motor 3) is provided with an amplifier unit (in this example, the amplifier unit A3) such that the amplifier unit is positioned at a position other than a position axially above a driving shaft of the motor. Therefore, according to the robot 1, it is possible to reduce the length of a member, which is obtained by assembling the motor and the amplifier unit, in a direction along the driving shaft of the motor.

In addition, in the robot 1, the amplifier unit includes a substrate (in this example, the amplifier substrate 63) including a drive circuit, and the motor is provided with the substrate such that the substrate becomes parallel to the driving shaft of the motor. Therefore, according to the robot 1, it is possible to reduce the length of the member, which is obtained by assembling the motor and the amplifier unit, in the direction along the driving shaft of the motor corresponding to the length of the substrate with which the motor is provided such that the substrate becomes parallel to the driving shaft of the motor.

In addition, in the robot 1, the first object and the motor are positioned axially above the driving shaft. Therefore, according to the robot 1, it is possible to reduce the length of a member, which is obtained by assembling the first object, the motor, and the amplifier unit, in the direction along the driving shaft of the motor.

In addition, in the robot 1, a computing unit (in this example, the computing unit OP) includes a control substrate (in this example, the control substrate CB2) including a control circuit that controls the motor. Therefore, according to the robot 1, it is possible to reduce the length of a member, which is obtained by assembling the computing unit that includes the control substrate including the control circuit that controls the motor, the motor, and the amplifier unit.

In addition, in the robot 1, the control substrate is provided axially above the driving shaft of the motor. Therefore, according to the robot 1, it is possible to reduce the length of a member, which is obtained by assembling the computing unit including the control substrate that is provided axially above the driving shaft of the motor, the motor, and the amplifier unit.

In addition, in the robot 1, the control substrate is positioned in an angle detector (in this example, the encoder 4). Therefore, according to the robot 1, it is possible to reduce the length of a member, which is obtained by assembling the computing unit that includes the control substrate positioned in the angle detector, the motor, and the amplifier unit.

In addition, in the robot 1, the first object includes a braking unit (in this example, the braking unit BK), the motive power transmitting unit, and the computing unit. Therefore, according to the robot 1, it is possible to reduce the length of a member, which is obtained by assembling the first object including the braking unit, the motive power transmitting unit, and the computing unit, the motor, and the amplifier unit.

In addition, in the robot 1, at least a portion of a control device (in this example, the robot control device) is positioned in a base (in this example, the base B1). Therefore, according to the robot 1 in which at least a portion of the control device is positioned in the base, it is possible to reduce the length of the member, which is obtained by assembling the motor and the amplifier unit, in the direction along the driving shaft of the motor.

In addition, in the robot 1, a first arm (in this example, the first arm A1) is provided on the base such that the first arm is rotatable around a first rotation axis (in this example, the first rotation axis AX1), and the robot 1 further includes a first casing (in this example, the first casing B2) that partially overlaps with the base as seen in an axial direction of the first rotation axis. Therefore, according to the robot 1 including the first casing, it is possible to reduce the length of the member, which is obtained by assembling the motor and the amplifier unit, in the direction along the driving shaft of the motor.

In addition, the robot 1 is a horizontal articulated robot. Therefore, according to the robot 1 being horizontal articulated robot, it is possible to reduce the length of the member, which is obtained by assembling the motor and the amplifier unit, in the direction along the driving shaft of the motor.

Hereinabove, the embodiment of the invention has been described with reference to the drawings. However, the specific configuration thereof is not limited to the embodiment and modification, substitution, and deletion may be made without departing from the spirit of the invention.

The entire disclosure of Japanese Patent Application No. 2017-017892, filed Feb. 2, 2017 is expressly incorporated by reference herein.

What is claimed is:

1. A robot comprising:
a motor;
an amplifier that includes a drive circuit for driving the motor; and
a first object that includes at least one of a brake which brakes a driving shaft of the motor, a pulley which transmits a motive power from the driving shaft of the motor, and a control substrate which performs calculation related to rotation of the motor,
wherein the motor is provided with the amplifier such that the amplifier is positioned at a position other than a position axially above the driving shaft.

2. The robot according to claim 1,
wherein the amplifier includes a substrate including the drive circuit, and
wherein the motor is provided with the substrate such that the substrate becomes parallel to the driving shaft.

3. The robot according to claim 1,
wherein the first object and the motor are positioned axially above the driving shaft.

4. The robot according to claim 1,
wherein the control substrate includes a control circuit that controls the motor.

5. The robot according to claim 4,
wherein the control substrate is provided axially above the driving shaft.

6. The robot according to claim 4,
wherein the control substrate is positioned in an angle detector.

7. The robot according to claim 1,
wherein the first object includes the brake, the pulley, and the control substrate.

8. The robot according to claim 1, further comprising:
a base;
a first arm provided on the base; and
a control device that controls the first arm,
wherein at least a portion of the control device is positioned in the base.

9. The robot according to claim 2, further comprising:
a base;
a first arm provided on the base; and
a control device that controls the first arm,
wherein at least a portion of the control device is positioned in the base.

10. The robot according to claim 3, further comprising:
a base;
a first arm provided on the base; and
a control device that controls the first arm,
wherein at least a portion of the control device is positioned in the base.

11. The robot according to claim 4, further comprising:
a base;
a first arm provided on the base; and
a control device that controls the first arm,
wherein at least a portion of the control device is positioned in the base.

12. The robot according to claim 5, further comprising:
a base;
a first arm provided on the base; and
a control device that controls the first arm,
wherein at least a portion of the control device is positioned in the base.

13. The robot according to claim 6, further comprising:
a base;
a first arm provided on the base; and
a control device that controls the first arm,
wherein at least a portion of the control device is positioned in the base.

14. The robot according to claim 7, further comprising:
a base;
a first arm provided on the base; and
a control device that controls the first arm,
wherein at least a portion of the control device is positioned in the base.

15. The robot according to claim 8,
wherein the first arm is provided on the base such that the first arm is rotatable around a first rotation axis, and
wherein the robot includes a first casing that partially overlaps with the base as seen in an axial direction of the first rotation axis.

16. The robot according to claim 1,
wherein the robot is a horizontal articulated robot.

17. The robot according to claim 2,
wherein the robot is a horizontal articulated robot.

18. The robot according to claim 7,
wherein the robot is a horizontal articulated robot.

19. The robot according to claim 8,
wherein the robot is a horizontal articulated robot.

20. The robot according to claim 15,
wherein the robot is a horizontal articulated robot.
